(19) United States
(12) Patent Application Publication
(10) Pub. No.: US 2007/0215606 A1
(43) Pub. Date: Sep. 20, 2007

(54) Wonder-flex induction coil

(76) Inventor: Timothy O. Albaugh, Galloway, OH (US)

Correspondence Address: Timothy O. Albaugh, 8799 Hubbard Dr. South, Galloway, OH, 43119, US

(21) Appl. No.: 11/384,572

(22) Filed: Mar. 20, 2006

(51) Int. Cl. H05B 6/42

(52) U.S. Cl. 219/677

(57) ABSTRACT

Induction heating coil for use in all types of induction heating applications. This coil is made from several strands of different size conductors incased inside of elastic, hose or tubing to contain fluid such as water or a mixture to cool the induction coil during operation. This induction coil can be operated at any frequency and at several different power levels. This coil is very flexible and can be shaped to any imaginable design by hand, and then reshaped to a different design to use in any configuration. This induction coil comes in several lengths and can be used for forging, tempering, preheating an array of different materials. It can be powered by any induction power supply. This has great benefits in the steel, welding, and injection molding industry.

### CROSS-REFRENCE TO RELATED APPLICATIONS

Not Applicable

### STATEMENT REGARDING FEDERALLY SPONSORED REASEARCH AND DEVELOPMENT

Not applicable

### REFERENCE TO SEQUENCE LISTINGS, A TABLE, OR A COMPUTER PROGRAM LISTING COMPACT DISC APPENDIX

Not Applicable

### BACKGROUND OF INVENTION

This invention pertains to many fields of use but deals specifically with heating conductive and non conductive materials for transformation into another shape or form. This is a primary component in the use of induction heating and the field of induction heating. For years we have made induction coils to specific shapes and sizes for the application. This is very expensive. Also many dies and forging equipment must be preheated which usually incorporates an inefficient resistance heating method. In the welding industry, many resistance heaters are used and are very expensive. Each coil in all these applications has to be made individual for each application. Several other fields using induction heating methods will also benefit with just one coil to fit all their applications.

### BRIEF SUMMARY OF THE INVENTION

This invention is a break through in the heating of parts or pieces in difficult positions and places. This product solves field difficulty issues with annealing in the welding industry. This product solves many of the cold die syndromes associated with all forging facilities. Being able to be portable and sized to any application solves many of the economic issues associated with all metal production facilities. This will help the welding industry greatly by using portable induction power supplies and our one size fits all coil to anneal welds and preheat before welding.

The idea of this coil is to use one coil to accomplish many heating applications quickly and efficiently.

### BREIF DESCRIPTION OF THE SEVERAL VIEWS OF THE DRAWING

FIG. 1a. represents an elastic cover. b. represents the conductor/s. c. represents the band for sealing. d. represents a conductor material of generic shape for connection to a inverted power source.

FIG. 2. e. represents an example of this invention currently being used.

FIG. 3. e. represents an example of this invention currently being used.

FIG. 4 g. represents a cross sectional area of a multistrand flex inductor.

FIG. 5 h. represents a cross section of a single strand flex inductor.

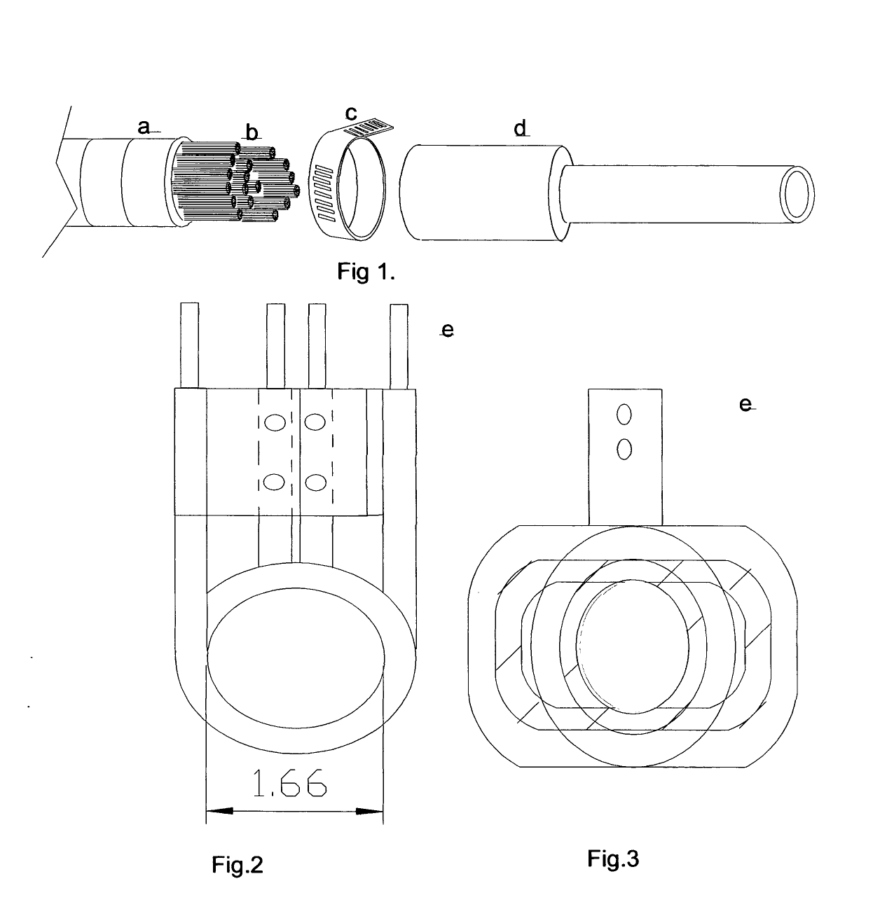

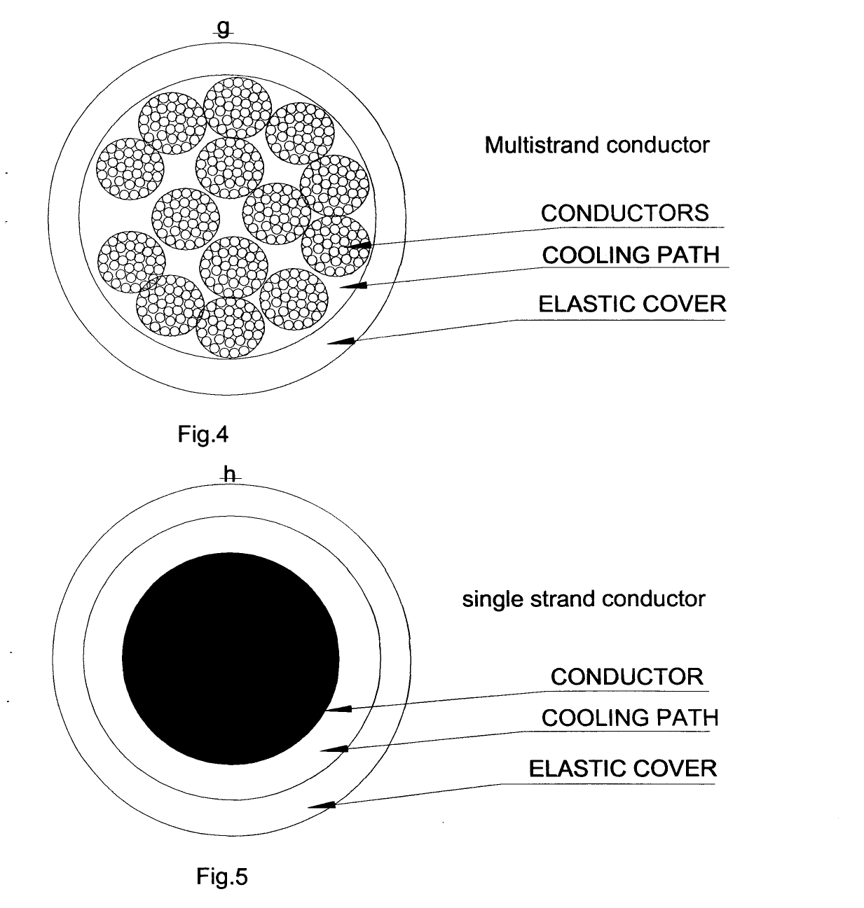

### DETAILED DESCRIPTION OF THE INVENTION

This invention requires three main components and they vary according to specific use. 1. By using an electrical conductor single or multistrand. 2. Encasing it with an elastic cover, hose, plastic, etc as to form a water passage for cooling fluid. 3. By means of sealing the ends with a conductive connector and a clamping mechanism. This flexible coil can be made any length and is limited only by coil design per application. Some heating applications may require 10 turns in a solenoid type coil; some applications may be in a pancake style form. There is no limit to the shapes that can be utilized by this product.

By designing the correct size and shape of coil required for a heating application, you can make a flexible coil to the length required and form it to the required shape. Using an inverted ac power supply, connect the coil to the electrical source and you can heat to several of many temperature ranges. Melting, forging, heat treating, brazing, soldering, crystal growth and much more.

I claim:

1. Flexible induction coil comprised of a flexible conductor or conductors surrounded by flexible elastic, rubber, plastic or other water sealed material to allow passage of a cooling medium.
Conductive material for connection to electrical source.
Provision to connect fluid inlet and fluid outlet to a source.
The above coil can be of any length to accommodate any application of heating using low frequency, medium frequency, and high frequency power source as the primary method of electrical power. By simply positioning the inductor around or upon the area to be heated the piece can be heated to the desired temperature and in the location desired.

2. Induction heating coil as claimed in claim 1 the conductive medium can be any material conductive to electricity and can be one or more conductors. The flexible cooling passage can be any material of elastic quality including but not limited to rubber, plastic, elastic and other flexible substrates.

3. Induction coil as claimed in claim 1 the cooling passage will be for any of several elastic materials and provide an inlet for cooling medium and an outlet for cooling medium.

4. Induction coil as claimed in claim 1 the provision for connection can be a conductive material that complies with the power source by standard connections or by specific means employed by design. A cooling medium inlet and outlet also supplied for said connectors as to accomidate the fluid medium.
